(19) United States
(12) Patent Application Publication
(10) Pub. No.: US 2009/0243322 A1
(43) Pub. Date: Oct. 1, 2009

(54) VEHICLE CARGO SPACE LINER WITH SNAP-CONNECTED EXTENSION

(75) Inventors: Clinton Anthony VANCE, Chanute, KS (US); Allan R. THOM, Clarendon Hills, IL (US)

Correspondence Address: Momkus McCluskey, LLC, 1001 Warrenville Road, Suite 500, Lisle, IL, 60532, US

(73) Assignee: David F. MACNEIL, Downers Grove, IL (US)

(21) Appl. No.: 12/060,352

(22) Filed: Apr. 1, 2008

(51) Int. Cl. B60R 13/01

(52) U.S. Cl. 296/39.1; 411/353

(57) ABSTRACT

A snap fastener has female and male snaps. The female snap, and in one embodiment the male snap, are thermoformed from sheets of thermoplastic material having a uniform thickness, in integration with the objects which the snaps are provided to join. In one use, an array of spaced-part fasteners is used to join a rear portion of a vehicle cargo liner to a front portion thereof. The fastener has particular application in fastening thermoformed articles of low flexural modulus.

### BACKGROUND OF THE INVENTION

Sport utility vehicles, minivans, station wagons and similar vehicles have a dedicated cargo space which is disposed to the rear of a last row of seats. It is known to produce after-market liners for these cargo spaces as a barrier against dirt, fluids and the like. Cargo liners have been developed that are custom-fitted to particular makes and models of vehicles. One method of manufacturing such cargo liners is to vacuum-mold or thermoform them from blanks of thermoplastic polymer, using a female mold. Desirable characteristics of such cargo liners are their ability to conform to the spaces for which they are custom-designed, to retain a “hair cell” or other nonsmooth finish which is initially pressed into the blank prior to thermoforming, and to exhibit desired characteristics such as enhanced coefficient of friction and a certain level of yieldability. Cargo liners and mats having these properties tend to have a low flexural modulus, i.e., they are floppy rather than stiff.

Vehicle manufacturers often provide SUVs and like vehicles with the ability to reconfigure the cargo and passenger areas. Sometimes a vehicle owner will wish to maximize the available cargo space; other times the owner will wish to seat more occupants. This is commonly achieved by taking seats out of the vehicle, or folding the seating into the floor or to the sides. Hence, many vehicle cargo spaces have at least two configurations: a first, more limited cargo area, and at least a second one in which the cargo area has been extended.

At least one company, Autoform i Malung AB of Malung, Sweden, has designed a two-part cargo liner in which has rear and front parts, wherein the rear part is used all of the time and the front part is used when it is desired to forwardly extend the vehicle cargo area. The rear part of the cargo liner has a female channel and the front part has a male rib which snaps into it. The channel runs in a transverse direction across the entirety of the part. The Autoform liner is believed to be formed from a sheet of high density polyethylene (HDPE) having a flexural modulus of about 180,000 psi. It is a relatively stiff and unyielding piece.

It has been determined that the channel/rib method of joining rear and front portions of cargo liners does not work well with materials having a flexural modulus that is considerably less than 180,000 psi; the parts come apart too easily. Therefore, another method of fastening one liner section to another liner section is needed.

### SUMMARY OF THE INVENTION

According to one aspect of the invention, a vehicle cargo liner has a rear portion for fitting into a corresponding rear portion of a vehicle cargo space, and a forward portion or extension for fitting into a forward portion of the vehicle cargo space. Both the front and rear portions of the cargo liner are thermoformed from uniformly thick sheets of thermoplastic polymeric material. A plurality of first snaps are integrally thermoformed with the rear portion so as to be distributed in spaced-apart relation to each other along and near the forward margin of the rear portion. A like plurality of second snaps are integrally thermoformed with the front portion so as to be distributed in spaced-apart relation to each other along and near a rear margin of the forward portion, in positions corresponding to the positions of the first snaps. The first snaps are engageable with the second snaps to fasten the front and rear portions of the cargo liner together.

In one embodiment, the snaps disposed on the rear cargo liner portion are male snaps and the snaps disposed on the front portion are female snaps. In this embodiment, it is preferred that the rear portion have molded therein a transverse registration rib against which the rear margin of the forward portion may be abutted. In another embodiment, the snaps disposed on the rear cargo liner portion are female snaps and the snaps disposed on the front portion are male snaps. This embodiment permits the provision of a forward raised lip, continuous with a like lip at least on the left and right margins of the part, which better holds fluid.

Preferably, the cargo liner is made from at least slightly elastic, thermoplastic material having a flexural modulus of no more than 100,000 psi. More preferably, the flexural modulus is 50,000 psi. Most preferably the flexural modulus is 5,600 psi. It is preferred to thermoform the rear and front sections from a thermoplastic elastomer, and more preferably a thermoplastic vulcanizate. While it is possible to make the front and rear portions from different materials, it is preferred that they may be made from blanks or sheets of the same material.

Preferably, the height of the snaps should be at least three times the thickness of the material from which the rear and front sections are thermoformed.

It is preferred that each of the female snaps have, as viewed in a section parallel to the general surface from which the snaps protrude, an endless wall. This closed wall enhances the firmness of the attachment and makes these snaps particularly suitable for the fastening of articles of low flexural modulus.

According to another aspect of the invention, a fastener includes a female snap integrally thermoformed from a sheet of thermoplastic material with the rest of an article to be fastened or attached, and a male snap adapted to be received into a cavity formed by the female snap. An enlarged head of the males snap, in width and depth directions, is larger than like dimensions of a constricted opening defined by a stem of the female snap. A largest width and depth of the female snap cavity is larger than the largest width and depth of the male snap head. In use, the male snap is pushed past the constriction and is held in place by the action of the female snap stem.

The male snap of this snap can have a morphology similar to the female snap, and can be integrally thermoformed as a portion of another article of thermoplastic material. Alternatively, the male snap can be an injection-molded plastic or even metal pier, and can for example be welded into original equipment manufacturer (OEM) vehicle carpeting to provide an anchor for a floor mat or tray. The female snap would be integrally formed into the mat or tray.

It has been discovered that the snaps according to the invention have superior utility in fastening together low-flexural-modulus thermoformed articles.

### BRIEF DESCRIPTION OF THE DRAWINGS

Further aspects of the invention and their advantages can be discerned in the following detailed description, in which like characters denote like parts and in which:

FIG. 1 is an isometric view of a vehicle cargo space taken through a rear hatch of a vehicle, showing the cargo space in a first configuration and a rear portion of a cargo liner installed therein;

FIG. 2 is an isometric view similar to FIG. 1, but showing the cargo space in a second, extended configuration and showing the deployment of both rear and front portions of a cargo liner according to the invention;

FIG. 3 is a partial isometric view, taken from a frontward and right outboard direction, showing a plurality of integral fasteners being used to attach a front cargo liner portion to a rear cargo liner portion;

FIG. 4 is an isometric detail of a male snap according to the invention;

FIG. 5 is an isometric detail of male and female snaps immediately prior to closure;

FIG. 6 is an isometric detail similar to FIG. 5, showing male and female snaps fastened together;

FIG. 7 is a cross-sectional view of the male and female snaps shown in FIG. 6;

FIG. 7A is a top sectional view taken substantially along line 7A-7A of FIG. 7;

FIGS. 7B and 7C are top sectional views, corresponding FIG. 7A, showing alternative snap shapes;

FIG. 8 is corresponding cross-sectional view of a vacuum mold detail used to form the female snap shown in FIGS. 5-7 and 7A;

FIG. 9 is an isometric view of a second embodiment of the invention in which a rear cargo liner portion retains a continuous raised peripheral lip;

FIG. 10 is a cross sectional view of a detail of the embodiment shown in FIG. 9, showing an area of connection between a rear cargo liner portion and a front cargo liner portion;

FIG. 11 is a schematic isometric view showing a female snap according to the invention being used to fasten a floor mat to a male pier in a vehicle foot well; and

FIGS. 12A and 12B are isometric views of a vehicle mat retention device employing a male snap for use with the invention.

### DETAILED DESCRIPTION

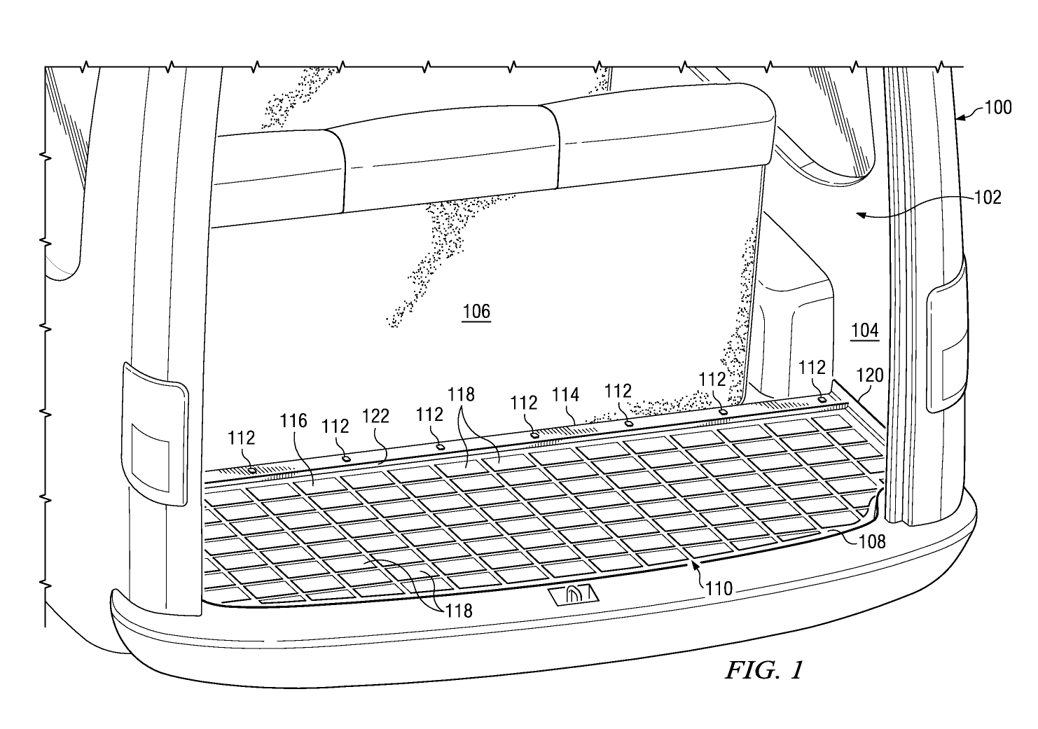

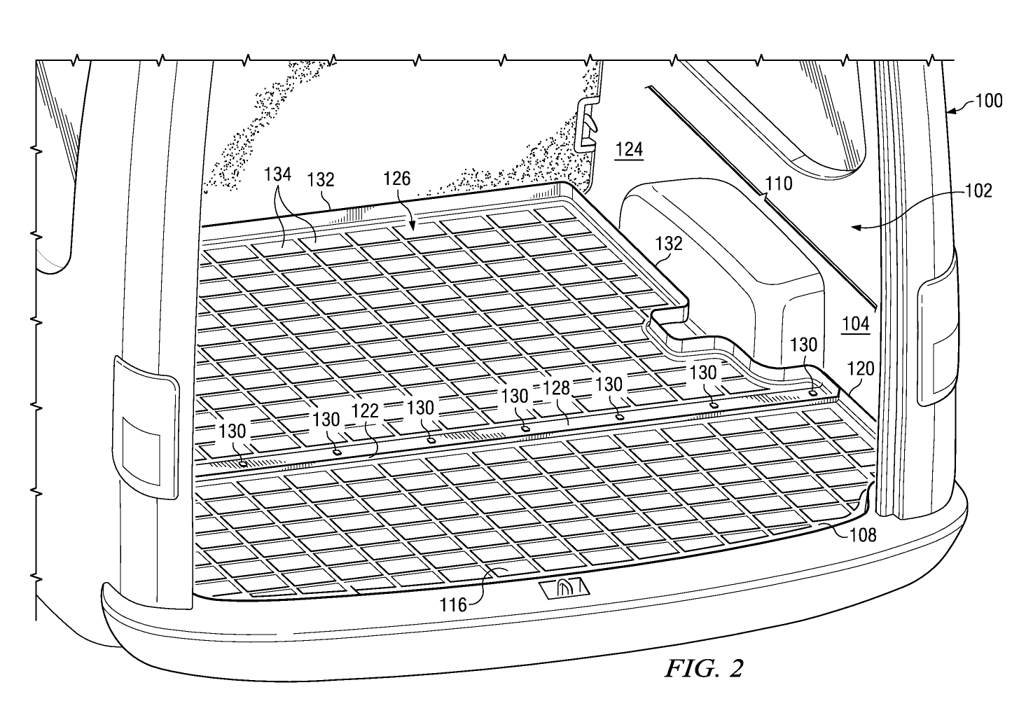

FIGS. 1 and 2 show a representative vehicle 100 having a rear cargo space 102. FIG. 1 shows this cargo space 102 in a first configuration, in which only a rear portion 104 is used as cargo space and in which a row 106 of seats occupies the space forward of this. In this configuration, it is enough to install a rear portion 108 of a cargo liner 110 into the rear cargo space portion 104. In the embodiment illustrated in FIGS. 1 and 2, the rear portion 108 has an array of male snaps 112 that are distributed along and near a forward margin 114 of the rear portion 108. The rear portion 108 has a generally flat upper surface 116 which may, as in this embodiment, have a repeating pattern of rectangles 118 or other ornamental surface treatment which may be thermoformed therein. The rear, left and right margins of the rear portion have a continuous raised lip 120 upstanding therefrom, which aids in retaining spilled fluid and the like. Immediately rearward of the snaps 112 is a transverse raised rib 122 which acts as a fluid barrier and also as a front cargo liner portion registration means, as will be hereinafter explained.

In FIG. 2, the vehicle 100 has been reconfigured to add additional, forwardly disposed cargo space 124 by removing seats 106. In this instance a forward cargo liner portion 126 is installed to extend the protection of rear cargo liner portion 108. The forward cargo liner portion 126 has a rear margin 128 which is shaped to register with the raised rib 122; in the illustrated embodiment both rib 122 and rear margin 128 are straight and orthogonal to the axis of vehicle travel, although they could be chosen to be otherwise. A little forward of the rear margin 128 is an array of female snaps 130 whose positions correspond to the male snaps 112 in the rear portion 108. To join the forward portion 126 to the rear portion 108, each female snap 130 is snapped over a respective male snap 112, such that the male snap is received into a cavity formed by the female snap 130, as will described in greater detail below. The right, left and forward margins of the forward portion 126 each terminate in a raised lip 132 that is meant to be a continuation of the raised lip 120 of the rear portion 108. Preferably the ornamentation of the rear portion 108 is repeated or continued in the front portion 126, here by a pattern of rectangles 134.

The forward and rear portions 108, 126 of the cargo liner are preferably thermoformed from sheets of a uniformly thick thermoplastic material. That is, the sheets or blanks making up portions 108, 126 are heated and drawn into a female mold under vacuum. This is a consideration in determining the number, size, height and spacing of the snaps 112, 130. There will be greater step coverage if the number of the snaps and their height can be minimized, and their spacing apart maximized. The number of snaps thermoformed into these parts should be no more than is sufficient to firmly affix the front portion 126 to the rear portion 108, given the sorts of tensile and shear forces that parts 126, 108 will be subjected to in normal use.

The two-part cargo liner 110 according to the invention is preferably thermoformed of uniformly thick blanks of thermoplastic material having a relatively low flexural modulus: they are floppy. Cargo liner 110 preferably is molded from a thermoplastic elastomer (TPE) and more preferably from a thermoplastic vulcanizate (TPV) which, for example, can be composed of particles of crosslinked rubber in a noncrosslinked polyolefin matrix. The inventors particularly prefer VYRAM, a family of thermoplastic vulcanizates made by ExxonMobil. The cargo liner 110 should have a certain yieldability for good properties relative to tactile acceptability, coefficient of friction, cushioning and sound-deadening. A durometer reading of about Shore A 75 is particularly preferred. While a thermoplastic vulcanizate is preferred for this application, the present invention has application to any situation in which one or more thermoformed articles, made from a material of relatively low flexural modulus, need to be fastened together or to other objects. The female snaps of the invention further require the articles with which they are integrally thermoformed to have a certain elasticity to exhibit the desired “snapping” closure.

The fasteners of the invention are particularly useful for articles thermoformed from a material which has a low flexural modulus. The flexural modulus of cargo liner portions 108 and 126, as measured using the test specified in ASTM D-790 Method 1, Process A (using a 1 in.×3 in.×0.125 in. sample of material), should be below 100,000 psi, and preferably below 50,000 psi. The material used in a particularly preferred embodiment has a flexural modulus of 5,600 psi. In one embodiment, the vacuum molds forming the rear portion 108 and the front portion 126 are “married” and accept sheets or blanks of thermoplastic material having the same thickness and composition.

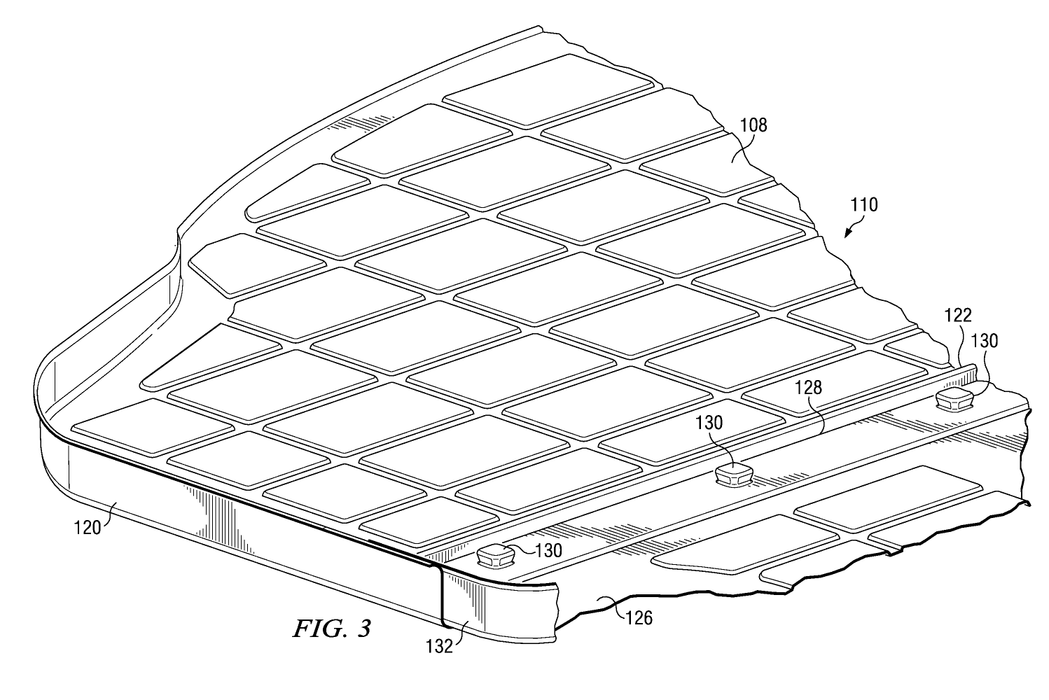

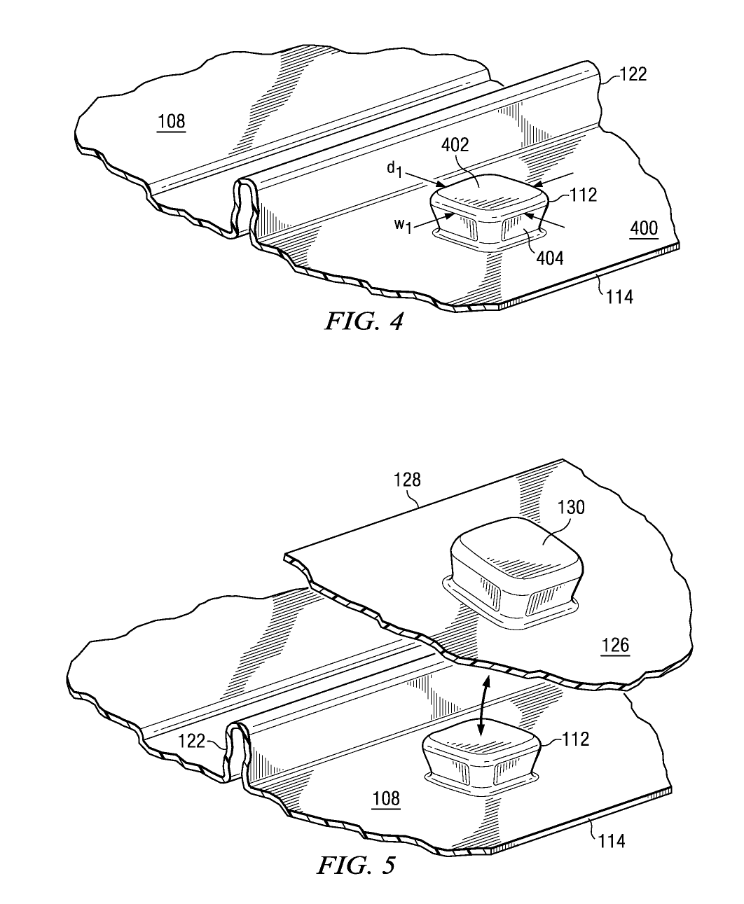

FIG. 3 shows joined portions of rear and forward portions 108, 126 in greater detail, and FIGS. 4 and 5 show greater detail still. In FIG. 4, the transverse registration rib 122 is shown to be thermoformed from a uniformly thick blank of thermoplastic material; after thermoforming, rib 122, like the remaining structure in portions 108, 126, will have a top surface, a substantially uniformly thick body, and a bottom surface which substantially mirrors or follows the top surface. The blanks from which portions 108, 126 are made can be prefinished with a tactilely pleasing “hair cell” or other finish, and this surface treatment will survive the thermoforming process.

As shown in the illustrated embodiment, the male snaps 112 and the female snaps 130 can have the same shape. Referring in particular to FIG. 4, each male snap 112 extends upwardly from a flat general upper surface 400 of the part with which it is thermoformed (in this embodiment, rear portion 108). The uppermost portion of the male snap 112 is formed as an enlarged head 402. A stem 404, of reduced cross section when compared with head 402, connects this head 402 to the general surface 400. In the illustrated embodiment, the stem 404 is formed by four frustopyramidal sidewalls and slope linearly inwardly from head 402 to surface 400. At its greatest girth, the head 402 has a dimension w₁ in a width direction, and a dimension d₁ in a depth direction. The width and depth directions are orthogonal to each other and are taken in a plane p₁ which is parallel to the plane in which the nearby portion of surface 400 resides.

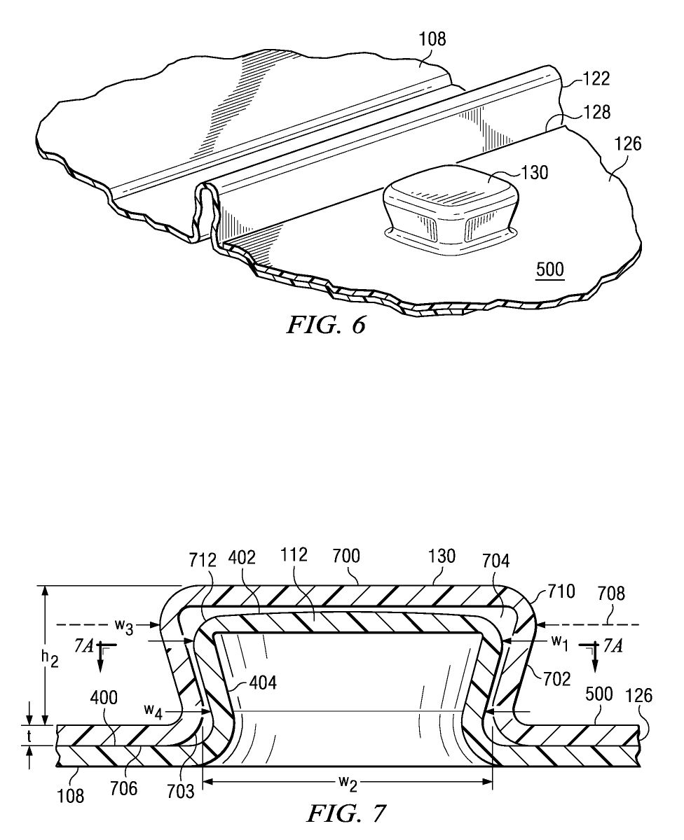

FIG. 5 shows how one of the female snaps 130 is snapped over a male snap 112 that occupies a corresponding position. A height of snap 130 as measured orthogonally upwardly from a general nearby flat surface 500 of the portion 126 should be at least three times the thickness of the sheet of material used to form portion 126. FIG. 6 shows portions 108 and 126 after the female snap 130 has been fastened onto male snap 112.

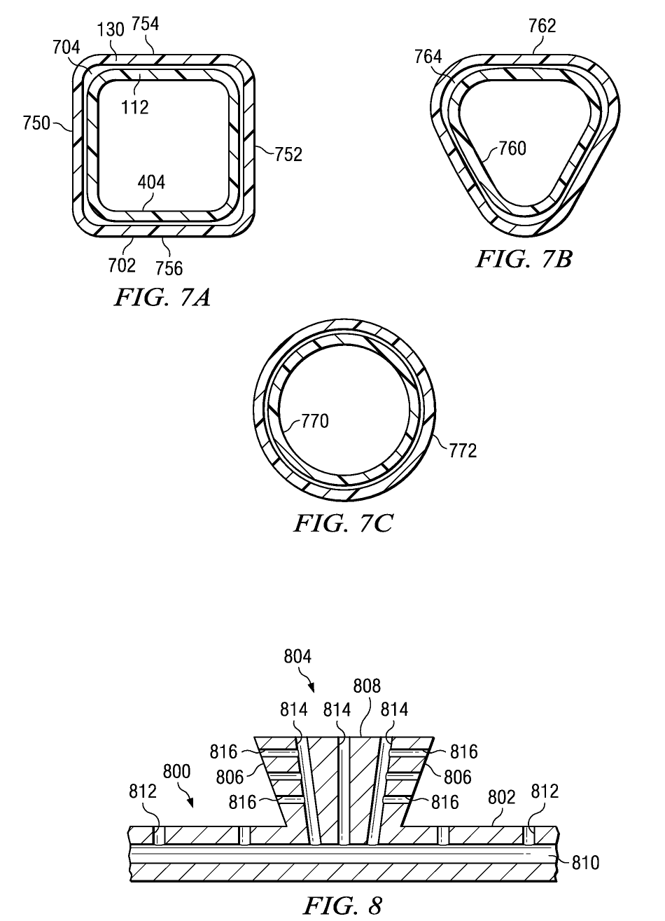

FIG. 7 shows a cross-sectional view taken in a width direction of male and female snaps 112, 130 in the condition they are in when snapped together. In the embodiment illustrated in FIGS. 4-7, a cross-sectional view in a depth direction would be essentially similar, and the description herein given of relative width dimensions also holds true for relative depth dimensions. Like its male counterpart, the female snap 130 has an enlarged head 700 at furthest remove from the general part surface 500, and the head 700 is joined to general planar surface 500 with a stem 702 of relatively constricted cross section. For proper function with a low flexural modulus (such as 5,600 psi) a height h₂ of the female snap 130 should be at least three times the thickness t of the sheet of material from which portion 126 is made. A lower, general planar surface 706 of the portion 126 is separated from planar surface 500 by thickness t.

The head 700 and stem 702 define a cavity 704 into which head 402 of the male snap 112 is to be inserted. The stem 702 defines an opening 703 with a minimum width w₂, at or near plane 500, which is smaller than the greatest width w₁ of the male snap head 402. The cavity 704 has a greatest width w₃, in a plane 708 that is spaced above surface 500, that is larger than the greatest width w₁ of the male snap head 402. A width w₄ of the male snap stem 404, as measured in plane 500 when the male and female snaps 112, 130 are snapped together, is less than or equal to width w₂ of the opening 703 of cavity 704.

In operation, when the female snap 130 is pressed downward on snap 112, the male snap head 402 will be forced beyond cavity opening 703 to occupy cavity 704. Since at least forward portion 126 is made out of somewhat elastic material, the frustopyramidal sidewalls making up stem 702 will hinge outward around a hinge made with head 700. Once the male snap head 402 is beyond opening 703, the female stem 702 will snap back into a less flexed or unflexed position, thereby retaining male snap 112 inside of cavity 704 defined by female snap 130.

As a result of the thermoforming process, the thickness of the thermoformed part will tend to decrease as it is sucked downward and along any vertical surface defined by the molding tool. Here, shoulders or hinges 710, 712 have a thickness which is reduced by as much as fifty percent from the uniform thickness t. This thinning imposes a constraint on the depth of the thermoformed feature.

Also as a result of the thermoforming process, the exterior surface of male snap 112 is not congruent with an interior surface defining cavity 704. Finally, the walls of female stem 702 will need some distance through which they can flex or hinge. For these reasons, the height of female snap 130 is chosen to be several times the thickness of the sheet blank, such as three times.

FIG. 7A is a top sectional view taken along line 7A-7A of FIG. 7. The plane of the section is parallel to and elevated from top surface 500. In this section, the female stem 702 and the male stem 404 both appear as an endless sidewall. When, for example, prying force exerted by an inserted male snap head 402 urges apart two longitudinal walls 750 and 752, two transverse walls 754, 756 joining the ends of walls 750, 752 will resist this force. This does not happen in a channel closure, where the analogs of either walls 750, 752 or 754, 756 do not exist. The fastener created by snaps 112, 130 is therefore a stronger or firmer closure than an open channel, and this is particularly the case if several spaced-apart snaps 112, 130 are provided to fasten one part to the other. For this reason, snaps 112, 130 are a more effective closure for low-flexural-modulus materials than an open channel would be.

FIGS. 7B and 7C illustrate variations on snap shapes, and are sectional views corresponding to the section shown in FIG. 7A. In FIG. 7B, the snaps 760, 762 take the shape of a rounded triangle; male snap 760 will be able to be snapped into the cavity 764 defined by female snap 762 in only one orientation. Conversely, male snap 770 and female snap 772 in FIG. 7C are of circular cross section and will permit free rotation of one snapped part to the other around the snap axis.

FIG. 8 is a detail of a female tool 800 used to mold an article and a snap integrally formed therewith. The tool 800 has a general flat surface 802 from which a snap forming member 804 upwardly extends. In the illustrated embodiment, where the sidewalls making up the snap are roughly frustopyramidal, the sidewall 806 of the member 804 will be likewise. It has been determined that for proper coverage and using the material described above, the degree of negative draft of the sidewalls 806 from a top surface 808 to general tool surface 802 should be no more than about twenty degrees.

Since it is a vacuum mold, the tool 800 is equipped with vacuum lines 810 (one shown) and numerous ports 812 in communication therewith which draw down the softened thermoplastic blank into the mold. The snap-forming member 804 has a number of vacuum lines 814 formed into it. Importantly, the sloped surfaces 806 each have a plurality of vacuum ports 816 to draw the softened material toward the sidewall 806.

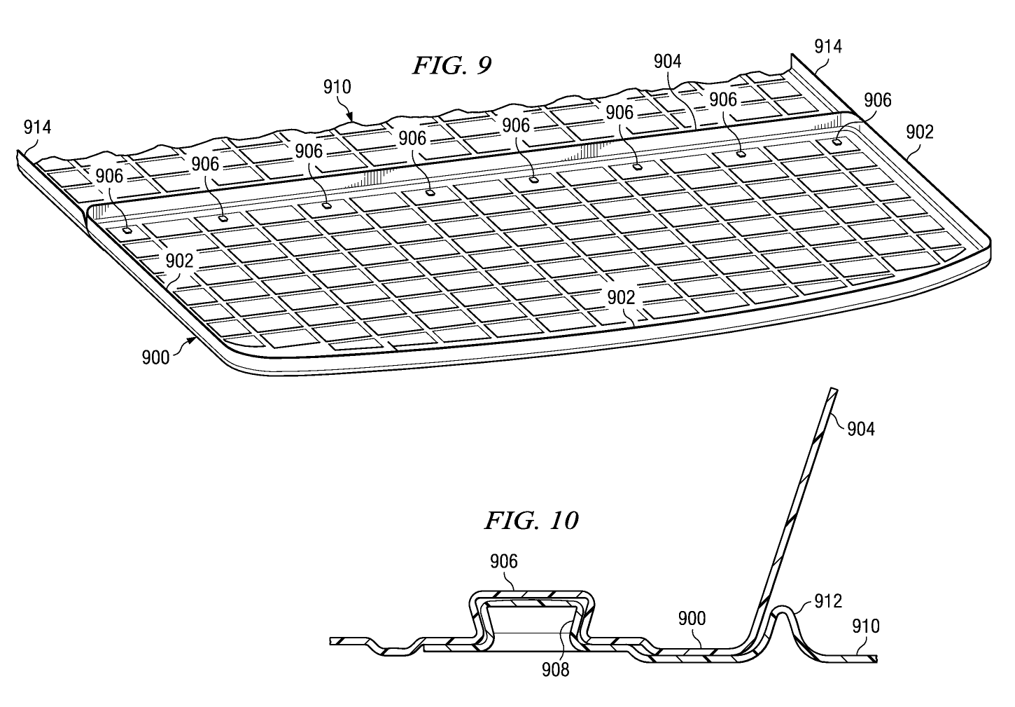

FIGS. 9 and 10 illustrate an alternative embodiment in which a rear cargo liner portion 900 has a continuous peripheral raised lip 902 at least on its left, forward and right margins (and preferably on its rear margin as well) so as to create an impervious barrier to fluid which may be sloshing about on its surface. This lip may, for example, be 1½ in. tall. In order to permit the inclusion of the forward lip portion 904, the rear cargo liner portion has integrally formed therein a plurality of female snaps 906, disposed near but rearward of lip 904. The female snaps 906 cooperate with male snaps 908 integrally formed in a forward cargo liner portion or extension 910. The forward portion 910 may have a transverse registration rib 912 to be abutted against a forward surface of raised lip 904, so as to better index the male snaps 908 to the female snaps 906. The forward portion 910 may have a raised lip 914 on its left, right and forward margins which matches up with lip 904.

This embodiment is particularly advantageous because consumers will typically use rear portion 900 all of the time, but front portion 910 only sometimes. Having lip 902 being peripheral to the entirety of rear portion 900 is therefore important.

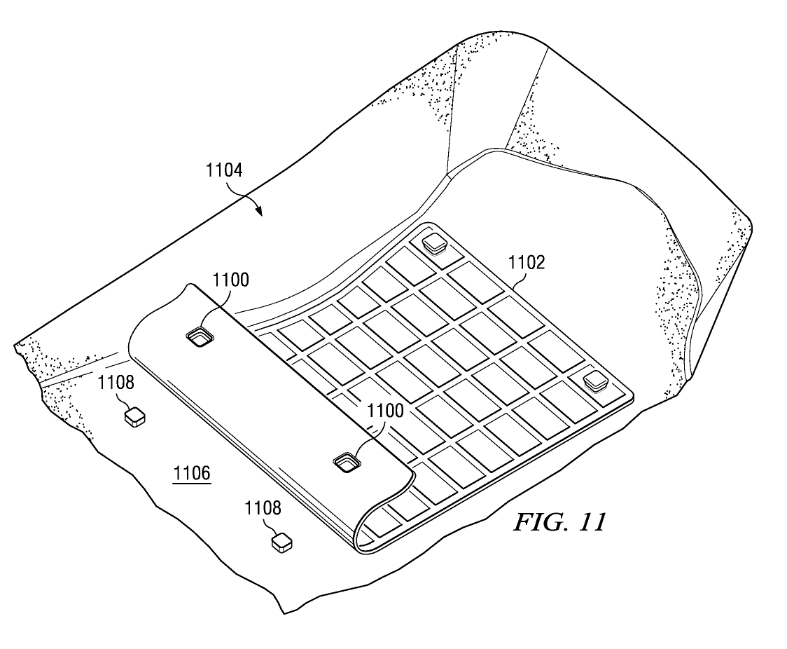

FIG. 11 illustrates an embodiment in which a plurality of female snaps 1100 are integrally molded into an article such as a floor mat 1102, for placement in a vehicle foot well 1104. The foot well is supplied with original equipment manufacturer (OEM) carpeting 1106 and can have, welded into the carpeting, a like plurality of male snaps or piers 1 108. The piers 1108 do not have to be thermoformed of a uniformly thick blank of material but instead can be solid injection-molded hard plastic or even metal. Nonetheless the ability to integrally form female snaps 1100 into mat 1102 obviates the necessity to provide other closure members. The present invention has application to any situation in which a relatively soft, thermoformed article is to be affixed to another object.

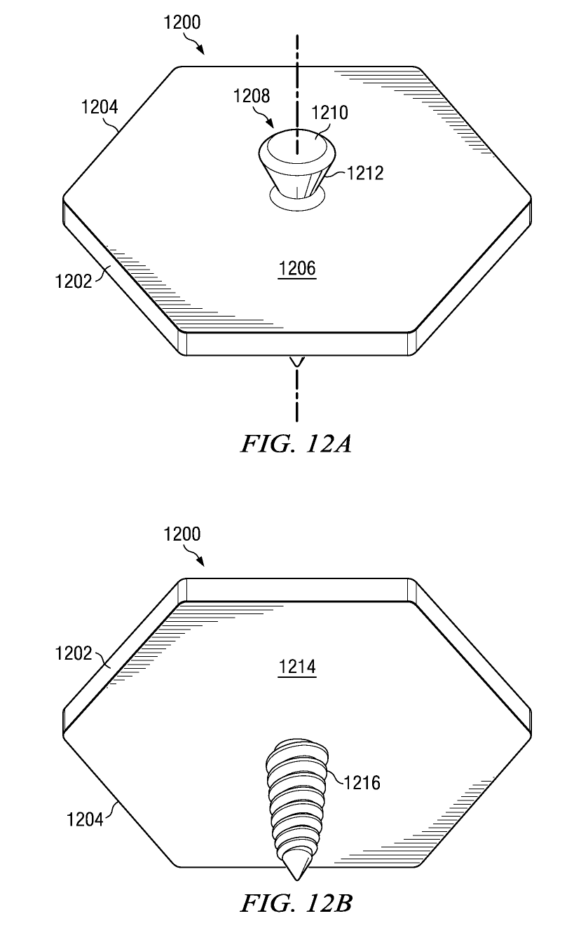

FIGS. 12A and 12B illustrate a fastener 1200 which can be used in place of one or more of the piers 1108 of FIG. 11. The fastener 1200 has a body 1202 of relatively flat aspect that includes a noncircular margin 1204 (in the illustrated embodiment, this margin is hexagonal). The body 1202 and margin 1204 are sized to give purchase points to a user's hand, as the fastener is designed to be able to be affixed to OEM carpeting without the aid of tools. A flat upper side 1206 of the body 1202 has formed thereon, and preferably coaxial with the rest of body 1202, a pier 1208 which has an enlarged head 1210 and a constricted stem or neck 1212, as previously described. This pier 1208 is adapted to be snapped into a cavity of a female snap member (not shown) formed in a floor mat or liner, similar to one of female snaps 1100 (FIG. 11). On a lower side 1214 of the body 1202 is formed a fastening element 1216 for joining the fastener 1200 to carpeting pile. This can, for example, be a central screw as shown. Alternatively the fastening element could be a pair of helical piercing tines or a bayonet fastener, of the kinds described in U.S. Pat. No. 6,735,819 B2, the specification of which is fully incorporated by reference herein. In use, the fastener 1200 is manually screwed into or otherwise affixed to the OEM carpet or vehicle foot well, using fastening element 1216. Side 1206 is then face-up and pier 1208 becomes available as a male snap member to which a corresponding female snap member may be affixed.

In summary, snap closures have been shown and described which may be integrally thermoformed with the articles they are design to fasten. The snaps may be used without metal inserts or the like, and as formed out of materials with low flexural modulus. The present invention has particular application to extensive articles thermoformed from blanks of thermoplastic elastomers, such as rear and forward portions of vehicle cargo liners.

While illustrated embodiments of the present invention have been described and illustrated in the appended drawings, the present invention is not limited thereto but only by the scope and spirit of the appended claims.

I claim:

1. A vehicle cargo liner, comprising:
a rear portion formed from a first, uniformly thick sheet of thermoplastic polymeric material and having a forward margin, the rear portion adapted for placement in a corresponding rear portion of a vehicle cargo space;
a front portion formed from a second, uniformly thick sheet of thermoplastic polymeric material and having a rear margin, the front portion adapted for placement in a forward portion of the vehicle cargo space so as to extend forwardly from the forward margin of the rear portion;
a plurality of first snaps integrally formed from the first sheet of material, the first snaps distributed in spaced-apart relation to each other along and near the forward margin; and
a plurality of second snaps integrally formed from the second sheet of material, the second snaps distributed in spaced-apart relation to each other along and near the rear margin of the front portion at positions corresponding to the positions of the first snaps, the first snaps engageable with respective ones of the second snaps to fasten the front portion of the cargo liner to the rear portion thereof.

2. The cargo liner of claim 1, wherein the first snaps are male snaps and the second snaps are female snaps each defining a respective cavity, respective male snaps adaptable to being snapped into the cavities of respective female snaps.

3. The cargo liner of claim 2, wherein the rear portion of the cargo liner has integrally formed therein an elongate transverse rib at a position rearward from the first snaps, the rib acting as a registration reference for the rear margin of the front portion of the cargo liner when it is desired to join the front portion of the cargo liner to the rear portion of the cargo liner.

4. The cargo liner of claim 1, wherein the second snaps are male snaps and the first snaps are female snaps each defining a cavity into which a respective second snap may be snapped.

5. The cargo liner of claim 4, wherein the rear portion of the cargo liner is generally flat, a raised lip formed to extend upwardly from the forward margin, the raised lip disposed forwardly of the first snaps, the forward margin of the rear portion of the cargo liner placed on top of the front portion of the cargo liner when it is desired to join the front portion of the cargo liner to the rear portion of the cargo liner.

6. The cargo liner of claim 5, wherein the rear portion of the cargo liner has a left margin and a right margin, the left and right margins each having a raised lip upwardly extending therefrom, the raised lip of the forward margin being continuous with the raised lips of the left and right margins.

7. The cargo liner of claim 1, wherein the flexural modulus of the second sheet of material is less than or equal to 100,000 psi.

8. The cargo liner of claim 3, wherein the flexural modulus of the second sheet of material is less than or equal to 50,000 psi.

9. The cargo liner of claim 4, wherein the flexural modulus of the second sheet of material is about 5,600 psi.

10. The cargo liner of claim 1, wherein the second sheet of material comprises a thermoplastic elastomer (TPE).

11. The cargo liner of claim 6, wherein the second sheet of material comprises a thermoplastic vulcanizate (TPV).

12. The cargo liner of claim 1, wherein the flexural modulus of the first sheet of material is less than 100,000 psi.

13. The cargo liner of claim 8, wherein the flexural modulus of the first sheet of material is less than 50,000 psi.

14. The cargo liner of claim 9, wherein the flexural modulus of the first sheet of material is about 5,600 psi.

15. The cargo liner of claim 1, wherein the first sheet of material comprises a thermoplastic elastomer (TPE).

16. The cargo liner of claim 11, wherein the first sheet of material comprises a thermoplastic vulcanizate (TPV).

17. The cargo liner of claim 1, wherein the thicknesses and compositions of the first and second sheets of material are the same.

18. The cargo liner of claim 15, wherein the rear portion has a general upper surface in the vicinity of the female snaps, the female snaps each extending by a predetermined height above the general upper surface, the raised lip having a height which is many times the height of the female snaps.

19. The cargo liner of claim 1, wherein either the first snaps or the second snaps are female snaps each defining a cavity, the other of the first snaps and the second snaps being male snaps, each male snap adapted to be snapped into a cavity of a female snap.

20. The cargo liner of claim 19, wherein the female snaps each extend by a predetermined height above a general surface of the portion in which the female snaps are formed, the height being at least three times the thickness of the uniformly thick sheet of material from which the last said portion is formed.

21. The cargo liner of claim 19, wherein the male snaps each extend by a predetermined height above a general surface of the portion in which the male snaps are formed, the height being at least three times the thickness of the uniformly thick sheet of material from which the last said portion is formed.

22. The cargo liner of claim 1, wherein each of the first snaps extend upwardly from a general surface of the rear portion, each of the first snaps, in a section taken in a plane parallel to the general surface, an endless wall.

23. The cargo liner of claim 22, wherein the shape of the endless wall as viewed in said section is noncircular.

24. The cargo liner of claim 22, wherein the shape of the endless wall as viewed in said section is circular.

25. A fastener, comprising:
a female snap integrally thermoformed from a sheet of thermoplastic material having a uniform thickness, the female snap formed at a first location, a general first surface of the sheet of thermoplastic material adjacent the first location occupying a first plane, a general second surface of the sheet of thermoplastic material adjacent the first location occupying a second plane spaced from the first plane by said thickness;
the female snap having a head which defines a cavity and a stem joining the head to the first surface and which defines an elastically expansible opening to the cavity, the opening intersecting the second plane and having a width in the second plane and a depth in the second plane which is orthogonal to the with thereof
a greatest width and depth of the cavity being orthogonal to each other and occupying a third plane spaced from the first plane in a direction opposite the second plane, the greatest width of the cavity being larger than the width of the opening, the greatest depth of the cavity being larger than the depth of the opening;
a male snap extending from a body of an object for insertion through the opening and into the cavity of the female snap, a general surface of the object, when the female and male snaps are fastened together, being adjacent the first location and the second plane, a head of the male snap extending from the second plane toward the first plane, a greatest width and a greatest depth of the head of the male snap being orthogonal to each other and occupying, when the female and male snaps are fastened together, a fourth plane located between and parallel to the third plane and the second plane, the greatest width of the head of the male snap being greater than the width of the opening of the female snap, the greatest depth of the head of the male snap being greater than the depth of the opening of the female snap; and
a stem of the male snap joining the head of the male snap to the general surface of the object, the stem, when the female and male snaps are fastened together, intersecting the second plane, a width of the stem of the male snap in the second plane being less than or equal to the width of the opening of the female snap, a depth of the stem of the male snap in the second plane being less than or equal to the depth of the opening of the female snap, such that when fastened the head of the male snap is inserted into the cavity of the female snap and such that during a fastening operation the opening of the cavity elastically expands around the head of the male snap and then contracts once the head of the male snap has been inserted beyond the opening into the cavity of the female snap.

26. The fastener of claim 25, wherein a height of the female snap as measured from the first plane to beyond the third plane is at least three times the uniform thickness of the sheet of thermoplastic material.

27. The fastener of claim 25, wherein the male snap is integrally thermoformed from a second sheet of thermoplastic material having a second uniform thickness.

28. The fastener of claim 27, wherein the second uniform thickness is the same as said uniform thickness.

29. The fastener of claim 27, wherein the second sheet of material is composed of a thermoplastic elastomer (TPE).

30. The fastener of claim 29, wherein the second sheet of material is composed of a thermoplastic vulcanizate (TPV).

31. The fastener of claim 27, wherein the flexural modulus of the second sheet of material is less than 100,000 psi.

32. The fastener of claim 31, wherein the flexural modulus of the second sheet of material is less than 50,000 psi.

33. The fastener of claim 32, wherein the flexural modulus of the second sheet of material is about 5,600 psi.

34. The fastener of claim 27, wherein the female snap is thermoformed in a first portion of a vehicle mat or liner, the male snap being thermoformed in a separate, second portion of the vehicle mat or liner, the male snap and the female snap being fastened together to join the first portion of the vehicle mat or liner to the second portion thereof.

35. The fastener of claim 25, wherein during thermoforming the female snap, a sidewall forming the head and stem of the female snap becomes thinner than said uniform thickness.

36. The fastener of claim 25, wherein the first sheet of material has a flexural modulus of less than 100,000 psi.

37. The fastener of claim 36, wherein the first sheet of material has a flexural modulus of less than 50,000 psi.

38. The fastener of claim 37, wherein the first sheet of material has a flexural modulus of about 5,600 psi.

39. The fastener of claim 25, wherein the male and female snaps have a shape in a plane parallel to the first plane which is circular.

40. The fastener of claim 25, wherein the male and female snaps have a shape in a plane parallel to the first plane which is non circular.

41. The fastener of claim 25, wherein as viewed in a section taken in the first plane, the the female snap is formed as an endless wall.

42. The fastener of claim 25, wherein the male snap is formed as a substantially inelastic pier.

43. The fastener of claim 42, wherein the object is a layer of carpeting permanently installed in a vehicle, the female snap being integrally formed as a portion of a mat or liner for installation over the carpeting.

44. A tool for thermoforming an article from a blank of thermoplastic material from a sheet of uniform thickness, comprising:
a tool body having a molding surface which defines the shape of the article, the molding surface substantially occupying a plane adjacent a first location;
at least one upstanding snap forming member formed at the first location to extend upward from the plane by a distance which is at least three times said uniform thickness, a sidewall of the snap forming member having a negative draft, vacuum lines formed in the snap forming member having openings in the sidewall to pull in the thermoplastic material toward the sidewall, the vacuum lines connected to a source of vacuum.

45. The tool of claim 44, wherein the negative draft is about 20 degrees.

46. The tool of claim 44, wherein a plurality of snap-forming members are formed at a respective plurality of locations on the molding surface in spaced-apart relation to each other.
